(19) United States
(12) Patent Application Publication
(10) Pub. No.: US 2006/0164920 A1
(43) Pub. Date: Jul. 27, 2006

(54) System and method for monitoring galactic time

(76) Inventor: Thomas Brophy, Encinitas, CA (US)

Correspondence Address: FOLEY & LARDNER LLP, P.O. BOX 80278, SAN DIEGO, CA, 92138-0278, US

(21) Appl. No.: 10/498,394

(22) PCT Filed: Dec. 13, 2002
(86) PCT No.: PCT/US02/39844

§ 371 Date: Mar. 30, 2005

Related U.S. Application Data
(60) Provisional application No. 60/341,480, filed on Dec. 14, 2001.

(51) Int. Cl. G04B 19/26; G04B 49/00

(52) U.S. Cl. 368/15

(57) ABSTRACT

The disclosed methods and device 26 for time-keeping precisely calculate data relating to the center of the Milky Way galaxy. A method of time-keeping includes determining a direction of the galactic center at a desired time, and at least one of the rise time, rise azimuth, and current elevation angle of the galactic center is calculated. Determining the direction may include calculating the coordinates of the galactic center in a celestial coordinate system of a predetermined ephemeral date. These coordinates are then transformed to a celestial coordinate system of the desired time. The transforming may include accounting for the precession of the equinox, the precession of the ecliptic plane, and variation of obliquity to the ecliptic. An indicator of the rise time 28, the rise azimuth 30 and/or the current elevation angle 32 is then displayed. The rise time, the rise azimuth and the current elevation angle may be determined for a desired position on Earth.

### RELATED APPLICATION

This application is related to, and claims priority under 35 U.S.C. § 119(e) of, U.S. provisional application Ser. No. 60/341,480 titled “GALACTIC DAWN CLOCK,” filed Dec. 14, 2001, which is hereby incorporated by reference in its entirety. U.S. provisional application Ser. No. 60/318,148 titled “GALACTIC ZODIA CALENDER, AND CALENDER SYSTEM CALIBRATION,” filed Sep. 7, 2001, is hereby incorporated in reference in its entirety.

### BACKGROUND OF THE INVENTION

1. Field of the Invention

The invention relates to time-keeping methods and devices. In particular, the invention relates to methods and devices for calculating and displaying time according to certain celestial ephemera.

2. Related Art

The information contained in this section relates to the background of the art of the present invention without any admission as to whether or not it legally constitutes prior art.

Clocks, watches and other timekeeping devices of various sorts have been used for centuries. Generally in human usage, timekeeping represents astronomical events of various sorts such as, for example, the motion of the earth around the sun, the motion of the moon around the earth, and the motion of the earth around its axis. Devices that measure and display those temporal events have utility for many obvious purposes.

Those astronomical events generally define “tropical time,” which is measured with respect to the Earth's motion about the Sun. Another basic category of time is “sidereal time,” which is measured with respect to the Earth's motion relative to the “fixed stars”. Sidereal timekeeping devices generally have utility in astronomy and navigation.

Sidereal time has had no generally apparent naturally occurring calibration or starting point—other than the “Big Bang” of creation that yields an imprecise calibration concept. Tropical time has the obvious starting points of the seasons (marked specifically by the equinoxes and solstices), and of sunrise and sunset. Sidereal time is usually calibrated to the “vernal point” or spring equinox, but the vernal point moves year by year and is essentially a tropical rather than sidereal basis.

Certain naturally occurring events having both a tropical and a sidereal basis have been identified as having an effect on human capacities. In particular, certain such events occurring according to a rhythmic cycle have been associated with levels of human creativity and anomalous cognition. For additional information on such effects, reference may be made to Spottiswoode, S. J. P., “Apparent Association Between Effect Size in Anomalous Cognition Experiments and Local Sidereal Time,” Journal of Scientific Exploration, Vol. 11, No. 2 (1997). The effects on anomalous cognition of rise of the center of our galaxy, referred to herein as “Galactic Dawn”, is of particular significance, as noted in Brophy, Thomas G., The Origin Map: Discovery of a Prehistoric, Megalithic, Astrophysical Map and Sculpture of the Universe, New York: Writers Club Press (October 2002). Further, archeological evidence suggests that ancient civilizations were aware of the significance of the position of the galactic center, as also noted in Brophy.

It would be desirable to measure time relative to naturally occurring combinations of tropical and sidereal events such as Galactic Dawn.

### SUMMARY OF THE INVENTION

According to a first aspect of the invention, a method of time-keeping comprises determining the direction of the galactic center at a desired time, and displaying an indicator of at least one of the rise time, the rise azimuth and the current elevation angle.

Time-keeping refers to the tracking of the passage of time or the indication of an approaching epoch. For example, time-keeping may refer to the amount of time that has passed since a predetermined event, such as a vernal equinox.

Galactic center, as used herein, refers to the center of the Milky Way galaxy. Those skilled in the art will understand that the solar system containing Earth is located on the periphery of the Milky Way galaxy.

A direction to the galactic center may include the direction from the center of Earth to the center of the Milky Way galaxy. Direction may be expressed as a set of coordinates in, for example, a celestial coordinate system. Alternatively, direction may be expressed as a pair of angles commonly known as Right Ascension and Declination.

“Rise time” refers to the approximate time of the rising of the galactic center over the horizon.

“Rise azimuth” refers to the approximate location on the horizon. Azimuth is typically measured as the angle from due north eastward. Thus, due east is 90 degrees, due south is 180 degrees, and due west is 270 degrees.

“Current elevation angle” refers to the angle between the current position of the galactic center and the horizon.

Displaying the direction may be accomplished in any of several ways. For example, the direction may be displayed as the coordinates or angles.

According to another aspect of the invention, a time-keeping device comprises means for determining a direction of galactic center at a desired time; means for calculating at least one of a rise time, rise azimuth and current elevation angle of galactic center; and means for displaying an indicator of at least one of the rise time, the rise azimuth and the current elevation angle.

According to yet another aspect of the invention, a program product comprises machine readable program code for causing a machine to perform method steps. The method steps include determining a direction of galactic center at a desired time; calculating at least one of a rise time, rise azimuth and current elevation angle of galactic center; and displaying an indicator of at least one of the rise time, the rise azimuth and the current elevation angle.

In a preferred embodiment, at least one of the rise time, the rise azimuth and current elevation angle of galactic center is calculated.

In a preferred embodiment, the determining of the direction comprises calculating coordinates of the galactic center in a celestial coordinate system of a predetermined ephemeral date; and transforming the coordinates to a celestial coordinate system of the desired time. In a further preferred embodiment, the transforming of the coordinates includes accounting for precession of equinox, recession of ecliptic plane, and changes in the obliquity of the ecliptic.

A celestial coordinate system is a non-rotating orthogonal coordinate system having its origin at the center of Earth. The z-axis extends through the Earth's north pole, and the x-axis extends in the direction of Aries, a distant constellation that is generally considered to be a fixed inertial reference.

Although this coordinate system is generally non-rotating, precessions of the ecliptic plane and the equinox result in temporal variations in the coordinate system.

The ecliptic plane is the plane of the Earth's orbit about the Sun. The obliquity of the ecliptic plane refers to the angle between the Earth's axis of rotation (the poles) and the ecliptic plane, currently approximately 23.5 degrees.

The precession of the ecliptic plane refers to the change in the orientation of the ecliptic plane in inertial space.

The equinox refers to the two points in the Earth's orbit about the Sun at which the Earth's axis of rotation is perpendicular to a line from the Sun to the center of Earth. These points are commonly used to mark the beginning of the spring and autumn seasons. The precession of the equinox refers to the movement of these points in the Earth's orbit due to a wobble of the Earth's axis of rotation.

In a preferred embodiment, the calculating of at least one of a rise time, rise azimuth and current elevation of galactic center determines at least one of the rise time, the rise azimuth and the current elevation angle for a desired position on Earth.

In a preferred embodiment, the displaying includes a digital display. In a further preferred embodiment, the digital display is on a wrist watch. In an alternate embodiment, the displaying includes a graphic display.

### BRIEF DESCRIPTION OF THE DRAWINGS

In the following, the invention will be explained in further detail with reference to the drawings, in which:

FIG. 1 is a flow chart illustrating the process of determining and displaying galactic center data according to one embodiment of the invention;

FIGS. 2A-2F illustrate the various coordinate transformations in determining the current position of the galactic center; and

FIG. 3 illustrates a device according to one embodiment of the invention.

### DESCRIPTION OF CERTAIN EMBODIMENTS OF INVENTION

The disclosed embodiments of the invention described herein identify, measure and display time according to a naturally occurring combination of tropical and sidereal events. Devices for keeping this time have utility for identifying human capacities that may occur on rhythmic cycles. This time also identifies a naturally occurring and useful daily starting point for sidereal time.

Although the description below focuses on data relating to galactic center, data relating to other celestial bodies of importance may also be determined according to the below-described methods.

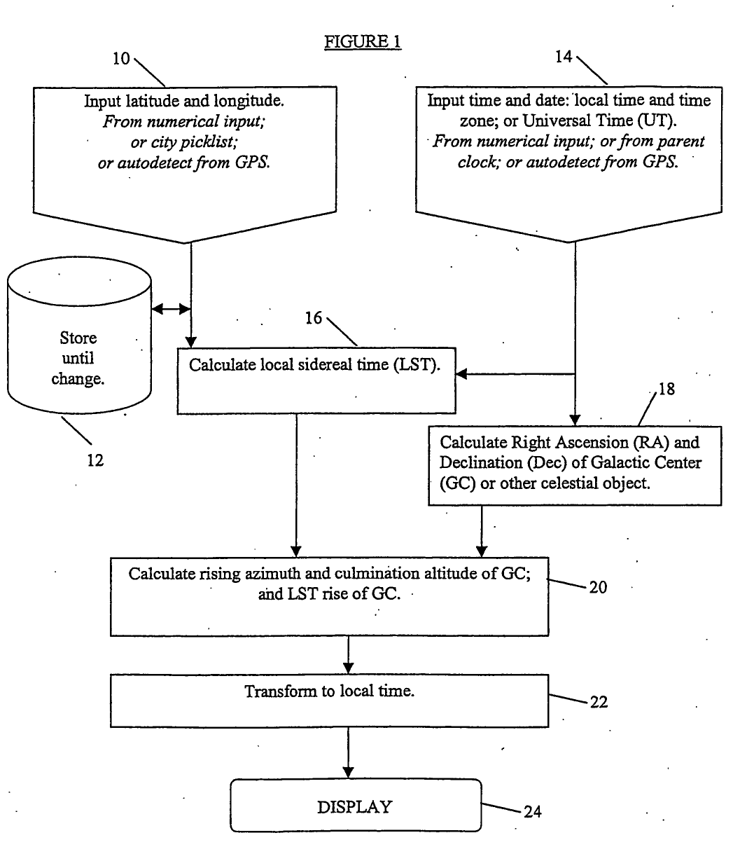

FIG. 1 illustrates a flow chart for calculating galactic center data according to an embodiment of the present invention. At block 10, position information of the user or observer is input. The information may be input by way of a user interface such as a graphical user interface on a personal computer or an input mechanism on a wrist watch. The position information includes the location of the user or observer on Earth and may include the latitude and longitude of the user. For additional precision, the position information may include the altitude of the user above a mean Earth radius. In other embodiments, the position information may be input by selecting one of a plurality of choices in a list. The list may include major metropolitan cities. In yet another embodiment, the information may be determined through an automatic positioning device such as a GPS receiver. The position information may be stored in a device memory, as illustrated in block 12, until the location of the user changes significantly. It should be noted that the position information may not necessarily correspond to the location of the user. For example, a user in New York may desire to obtain galactic center information for another city such as Los Angeles. In this case, the position information for Los Angeles would be entered.

At block 14, information relating to the time at which information is desired is input. The time may be current time or any other time. For example, a user may wish to obtain galactic center information for a future date. The time information may be input in the form of time zone, local time and date. Alternatively, the information may be input as the date and Universal Time (UT), or Greenwich Mean Time (GMT). In another embodiment, the time may be automatically obtained through a parent clock or from a GPS receiver.

At block 16, the time and position information is used to calculate local sidereal time (LST). LST is independent of time zone. For example, although Los Angeles and Phoenix may be in the same time zone, the 400-mile east-to-west distance between them results in more than one-hour difference in sidereal time. The calculation of sidereal time is well-known to those skilled in the art and will not be described here in detail.

Referring now to block 18, the time information can be used to calculate the position of a celestial object, such as the galactic center, at the desired time. The position of the galactic center may be expressed in terms of right ascension and declination.

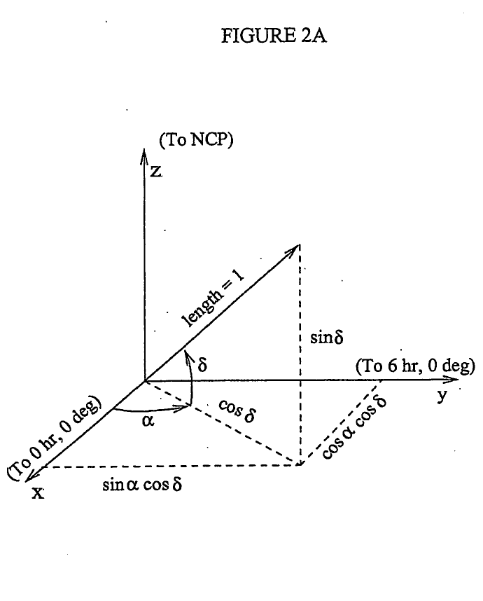

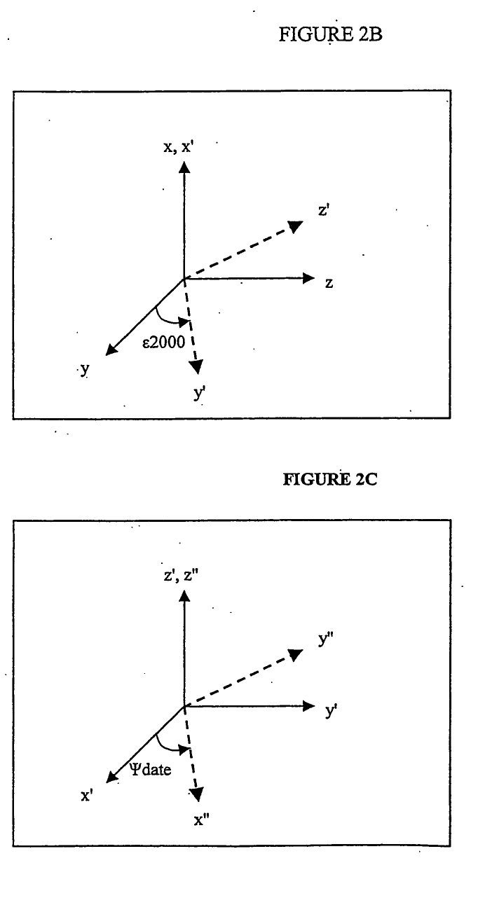

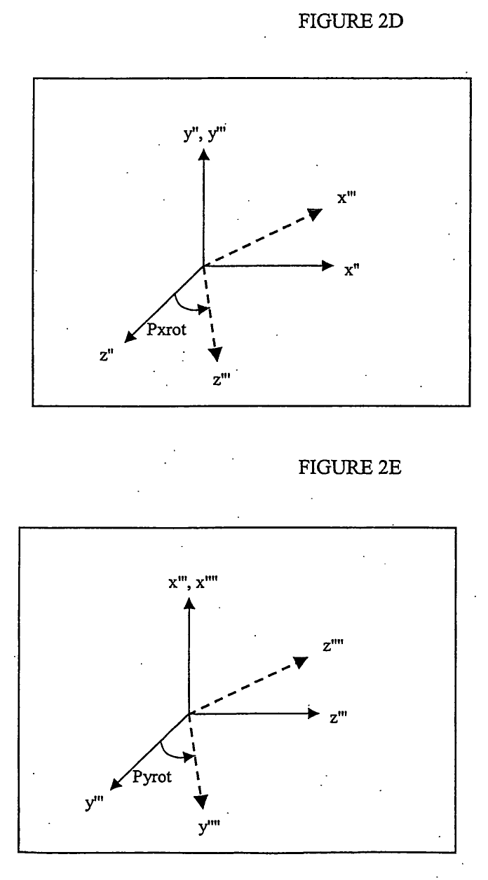

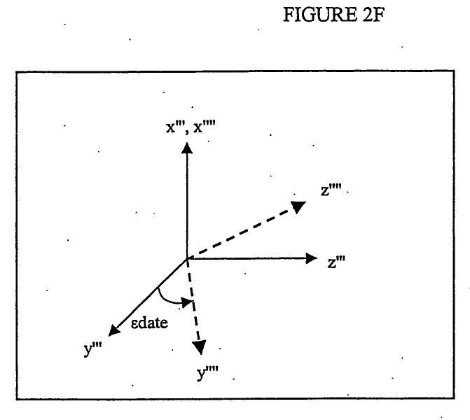

Right ascension and declination are illustrated in FIG. 2A for the galactic center on a celestial coordinate system for a predetermined ephemeral date such as, for example, Jan. 1, 2000. Right ascension (a) is defined as the angle along the Earth equatorial plane (x-y plane) between a line from Earth center to the object (unit vector to coordinates (a,b,c)) and a line from Earth center to Aries (the x-axis). Declination (5) is defined as the angle between the Earth equatorial plane and the line from Earth center to the object.

The calculation in block 18 of FIG. 1 of the right ascension and declination of the galactic center at the desired time may be precisely performed by applying the rotations illustrated in FIGS. 2A-2F. Referring first to FIG. 2A, the position of the galactic center on, for example, Jan. 1, 2000, is first converted from the right ascension and declination angles to a unit vector in the xyz celestial coordinate system of Jan. 1, 2000. The celestial coordinate system is a non-rotating, orthogonal coordinate system with its origin at the Earth's center. The x-axis is directed toward an inertial reference, typically Aries. The z-axis is directed through the Earth's north pole. Thus, the coordinates of the unit vector may be expressed as:
x=cos(α) sin(δ)
y=sin(α) cos(δ)
z=sin(δ)

Referring now to FIG. 2B, the galactic center position of Jan. 1, 2000, is now converted to a representation in an ecliptic coordinate system of that ephemeral date. The ecliptic coordinate system is also an Earth-centered, orthogonal coordinate system with its x-axis directed to Aries. The z-axis of the ecliptic coordinate system is directed perpendicular to the plane of the ecliptic. The plane of the ecliptic is the plane defined by the Earth's orbit about the Sun. Thus, obtaining the coordinates of the galactic center on Jan. 1, 2000, in the ecliptic coordinate system of that date merely requires a rotation about the x-axis by the angle between the Earth's axis of rotation and the ecliptic poles. This angle, ε₂₀₀₀, is generally approximately 23.437 degrees. Improved methods of geodetic history may provide a more precise measurement of this angle. Thus, the coordinates of the galactic center in ecliptic 2000 coordinates may be represented as:
x′=x
y′=y*cos(ε₂₀₀₀)+z*sin(ε₂₀₀₀)
z′=−y*sin(ε₂₀₀₀)+z*cos(ε₂₀₀₀)

Referring now to FIGS. 2C-2F, the coordinates of the galactic center are now updated from the galactic center direction of the predetermined ephemeral date to the desired date. First, with reference to FIG. 2C, the change in the direction due to the general precession of the equinox is accounted for. The equinox refers to the two points in the Earth's orbit about the Sun at which the Earth's axis of rotation is perpendicular to a line from the Sun to the center of Earth. These points are commonly used to mark the beginning of the spring and autumn seasons. The general precession of the equinox refers to the movement of these points in inertial space relative to their reference point (e.g., Jan. 1, 2000) due to a wobble of the Earth's axis of rotation. Generally, the Earth's axis completes one wobble every 26,000 years. For a precise calculation of galactic center data, this precession should be accounted for. The precession may be represented by rotating the ecliptic coordinate system about the z-axis by the general precession of the equinox between the predetermined ephemeral date (e.g., Jan. 1, 2000) and the desired time. The precession may be represented as an angle, ψ_{date}. For detailed calculations of this angle, reference may be made to A. L. Berger, Journal of the Atmospheric Sciences, 1979, Bol. 35, pp. 2362-67. The precession yields the following coordinates:
x″=x′*cos(ψ_{date})+y′*sin(ψ_{date})
y″=x′*sin(ψ_{date})+y′*cos(ψ_{date})
z″=z′

Next, with reference to FIGS. 2D and 2E, the change in the direction due to the precession of the ecliptic plane is accounted for. The precession of the ecliptic plane refers to the change in the orientation of the ecliptic plane in inertial space. The change in this angle between the predetermined ephemeral date and the desired time may be expressed as rotations first about the y″-axis by the angle Pₓᵣₒₜ (FIG. 2D), and then about the x″-axis by the angles P_{yrot} (FIG. 2E). For detailed calculations of these angles, reference may be made to A. L. Berger, Astronomy and Astrophysics, Vol. 51, pp. 127-135 (1976). These rotations yield the following coordinates:
x′″=z″*cos(Pₓᵣₒₜ)+y″*sin(Pₓᵣₒₜ)
y′″=y″
z′″=z″*sin(Pₓᵣₒₜ)+y″*cos(Pₓᵣₒₜ)
and
x″″=x′″
y″″=y′″*cos(P_{yrot})+z′″*sin(R_{yrot})
z″″=y′″*sin(P_{yrot})+z′″*cos(P_{yrot})

Now, with all temporal variations accounted for, (x″″,y″″,z″″) represent the coordinates of the galactic center unit vector in the ecliptic coordinate system of the desired date. In order to obtain the right ascension and declination of the galactic center for the desired date, the coordinates must be converted to the celestial coordinate system for the desired date, as illustrated in FIG. 2F. This may be accomplished by a rotation about the x″″-axis by the angle between the Earth's axis of rotation and the ecliptic poles at the desired time, ε_{date}:
x′″″=x″″
y′″″=y″″*cos(ε_{date})+z″″*sin(ε_{date})
z′″″=y″″*cos(ε_{date})+z″″*cos(ε_{date})

ε_{date} differs from ε₂₀₀₀ by the amount of variation of Earth's spin axis obliquity to the ecliptic pole.

The right ascension and declination may now be calculated as:
α_{date}=arctan (y′″″/x′″″)
δ_{date}=arcsin(z′″)

Referring again to FIG. 1, the right ascension and declination (block 18) and the LST (block 16) may now be used to calculate the rise azimuth, culmination altitude and the rise time of the galactic center in block 20. On vernal equinox, at a given latitude on Earth, celestial objects that rise above the horizon at the same time as the Sun have the following relation between their right ascension and declination:
sin(α)=−{sin(latitude)sin(δ)}/{cos(latitude)cos(δ)}

Thus, for any given latitude, longitude and date, the local rise time with respect to the Sun of the galactic center may be uniquely determined. Combined with the standard relation between longitude, Universal Time (UT) and local vernal equinox sun rise time, the absolute rise time of the galactic center on any date may be uniquely determined.

The rise time may now be converted to local clock time (block 22). For example, the latitude and longitude information may be used to determine the local time zone to convert the local sidereal time to local clock time. The calculated data may now be displayed to the user (block 24).

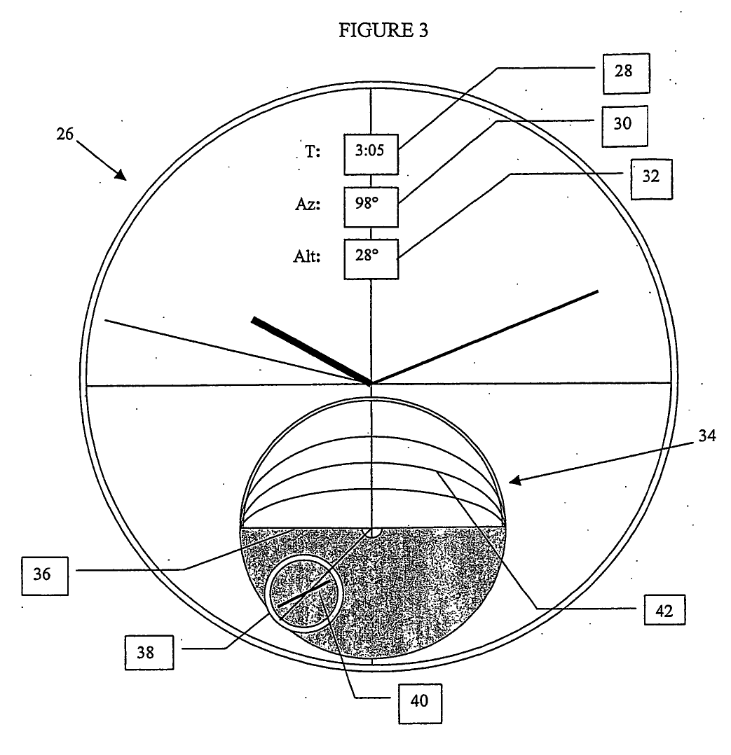

The displaying of the data may be performed in any number of ways. For example, the data may be presented on a computer monitor. In one embodiment, illustrated in FIG. 3, the data is presented on a wrist watch face. In this embodiment, a wrist watch face 26 is provided with digital readouts for the time remaining to next galactic center rise 28, the rise azimuth 30 and the current elevation angle 32 of the galactic center. Further, the data relating to the galactic center may be presented in a graphic manner, as indicated generally by reference numeral 34. The graphic display indicates a center line representing a horizon 36. A sweep arm 38 is provided to indicate the current elevation angle of the galactic center. In the illustrated example, the sweep arm 38 is in the shaded region, indicating that the galactic center is below the horizon. A bar 40 may be provided on the sweep arm 38 to indicate the orientation of the galactic plane relative to the horizon. The graphic display 34 may also contain a plurality of curves 42 to indicate the altitudinal path of the galactic center through the sky. Each line indicates the path for a particular Earth latitude.

The digital and graphical displays illustrated in FIG. 3 may be implemented as either electronic displays or mechanical displays. Those skilled in the art will appreciate that a watch gear system may be used to implement the displays.

The position of the galactic center may also be used as the basis of a calendar system. In this regard, using the above-described techniques, a calendar may be calibrated according, for example, an alignment of the galactic center with the y-axis of the celestial coordinate system. Thus, a cycle may be obtained in which Year 1 begins at a point at which the right ascension of the galactic center is 90 degrees. Each 360-degree “revolution” of the right ascension of the galactic center may be considered a single cycle, with the next cycle beginning once the right ascension of the galactic center returns to 90 degrees.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A method of time-keeping, comprising:
determining a direction of galactic center at a desired time; and
displaying an indicator of at least one of said rise time, said rise azimuth and said current elevation angle.

2. The method according to claim 1, wherein said determining a direction comprises:
calculating coordinates of said galactic center in a celestial coordinate system of a predetermined ephemeral date; and
transforming said coordinates to a celestial coordinate system of said desired time.

3. The method according to claim 2, wherein said transforming includes accounting for at least one of precession of equinox, precession of ecliptic plane and variation in obliquity of ecliptic plane.

4. The method according to claim 1, further comprising:
calculating at least one of the rise time, rise azimuth and current elevation angle of galactic center,
wherein said calculating determines at least one of the rise time, the rise azimuth, and the current elevation angle for a desired position on Earth.

5. The method according to claim 1, wherein said displaying includes a digital display.

6. The method according to claim 5, wherein the digital display is on a wrist watch.

7. The method according to claim 1, wherein said displaying includes a graphic display.

8. A time-keeping device, comprising:
a display of an indicator of at least one of said rise time, said rise azimuth and said current elevation angle of said galactic center.

9. The device according to claim 8, comprising:
means for determining a direction of galactic center at a desired time; and
means for calculating at least one of a rise time, rise azimuth and current elevation angle of galactic center.

10. The device according to claim 9, wherein said means for determining is adapted to calculate coordinates of said galactic center in a celestial coordinate system of a predetermined ephemeral date and to transform said coordinates to a celestial coordinate system of said desired time.

11. The device according to claim 9, wherein said means for calculating is adapted to determine at least one of the rise time, the rise azimuth, and the current elevation angle for a desired position on Earth.

12. The device according to claim 8, wherein said display includes a digital display.

13. The device according to claim 8, wherein said display includes a graphic display.

14. A program product, comprising machine readable program code for causing a machine to perform following method steps:
determining a direction of galactic center at a desired time; and
displaying an indicator of at least one of said rise time, said rise azimuth and said current elevation angle.

15. The program product according to claim 14, wherein said determining a direction comprises:
calculating coordinates of said galactic center in a celestial coordinate system of a predetermined ephemeral date; and
transforming said coordinates to a celestial coordinate system of said desired time.

16. The program product according to claim 15, wherein said transforming includes accounting for at least one of precession of equinox, precession of ecliptic plane and variation in obliquity of ecliptic plane.

17. The program product according to claim 14, further comprising machine readable program code for causing a machine to perform following method steps:
calculating at least one of the rise time, rise azimuth and current elevation angle of galactic center,
wherein said calculating determines at least one of the rise time, the rise azimuth, and the current elevation angle for a desired position on Earth.

18. The program product according to claim 14, wherein said displaying includes a digital display.

19. The program product according to claim 18, wherein the digital display is on a wrist watch.

20. The program product according to claim 14, wherein said displaying includes a graphic display.

21. A calendaring method, comprising:
selecting an orientation of the galactic center as the origin of a calendar;
generating a calendar based on time passed from the orientation of the galactic center at origin.
